(19) United States
(12) Patent Application Publication
(10) Pub. No.: US 2008/0184156 A1
(43) Pub. Date: Jul. 31, 2008

(54) Controlling apparatus, controlling method and computer readable recording medium storing controlling program

(75) Inventor: Masatoshi Sato, Sagamihara-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 12/000,033

(22) Filed: Dec. 7, 2007

(30) Foreign Application Priority Data
Jan. 29, 2007 (JP) 2007-017380

(51) Int. Cl. G06F 3/048

(52) U.S. Cl. 715/777

(57) ABSTRACT

There is described a controlling apparatus which makes it possible to improve the user's maneuverability at the time of setting operations to be conducted in a first screen in which represented are a plurality of tabs and a plurality of items corresponding to a selected one of the tabs. The controlling apparatus provided with at least a setting control section that controls a display device, wherein when the user designates a given tab, which is not currently selected, with a cursor or a pointer, the setting control section controls the display device to display on or a vicinity of the first screen a second screen, in which at least one of names of a plurality of items corresponding to the given tab is represented.

### CROSS-REFERENCE TO RELATED APPLICATION

This application is based on Japanese Patent Application No. 2007-017380 filed on Jan. 29, 2007, with Japan Patent Office, the entire content of which is hereby incorporated by reference.

### BACKGROUND OF THE INVENTION

1. Field of the Invention

The present invention relates to a controlling apparatus, a controlling method and a computer readable recording medium controlling program, and specifically relates to a controlling apparatus for controlling an image forming apparatus, a controlling method in the controlling apparatus concerned and a computer readable recording medium storing a controlling program to be executed in the controlling apparatus concerned.

2. Description of Related Art

In recent years, there have been increasingly proliferated in the market various kinds of copiers or multi-functional apparatuses, each provided with a combination of plural functions, such as a copy function, a facsimile function, a printer function, a scanner function, etc., (hereinafter, referred to as an image forming apparatus as a general term for each of them). When the image forming apparatus is employed as the network printer to implement the printing operation, at first, the concerned document is created by using the application program installed in advance in the computer terminal device coupled to the network, and then, the created document is converted to the print data in the format of the Page Description Language (hereinafter, also referred to as the PDL, for simplicity) by employing software (printer driver) for controlling the image forming apparatus, so as to be transmitted to the image forming apparatus concerned. Receiving the print data from the computer terminal device, the image forming apparatus parses the print data to create intermediate data, and then, further converts the intermediate data to bitmap data, so as to output an image based on the bitmap data onto a paper medium. When printing the abovementioned document, various kinds of printing conditions are set by using a screen (for instance, a document property screen) displayed by the printer driver. However, since the document property screen includes a lot of items to be set, the tabs by which the items to be set are categorized into plural corresponding groups are provided in advance within the concerned screen layout, so that the user can display the corresponding screen by selecting a desired tab, in order to set the detail items displayed on the selected screen, and as needed, the user can further display the other corresponding screen by selecting another desired tab, to set the detail items displayed on the currently selected screen. In other words, the user should sequentially select the plural tabs one by one, to set the various kinds of printing conditions.

Accordingly, there has been a problem in such the printer driver as mentioned in the above that the user who is not familiar with the screen layout of the document property screen cannot recognize, into which tab a certain item, other than the items displayed on the screen corresponding to the tab currently selected, is categorized, without changing the tabs. Further, there has been another problem that, when a screen corresponding to a next separate tab is displayed, it is impossible even for the user who is familiar with the screen layout of the document property screen to confirm what kind of settings have been established in the previous screen, also resulting in deterioration of its maneuverability.

From the abovementioned circumstances, it has been desired that the user can recognize the items, which are settable in each of the tabs, or the user can easily confirm the result of setting the items concerned. Accordingly, for instance, Tokkai 2004-54432 (Japanese Non-Examined Patent Publication) sets forth a screen configuration in which the fundamental operating screen for setting the various kinds of conditions is displayed on the upper side of the display screen; the setting contents confirming screen in the tab structure for listing the setting status of each item is displayed on the left side of the display screen; and the setting-item detail setting screen of the tab selected in the setting contents confirming screen is displayed on the right side of the display screen, so as to make it possible to easily confirm the setting content of each item on the setting screen by displaying the setting contents confirming screen within the range of the setting screen.

However, according to the configuration set forth in Tokkai 2004-54432, since each of the tabs also serves as the setting contents confirming screen so as to display the list of the setting status of each of the items, the display area necessary for displaying such the contents becomes larger than that required for its inherent tab function. Accordingly, there has been a problem that a display area to be allotted to the fundamental operating screen and the setting-item detail setting screen is inevitably reduced.

The abovementioned problems occur not only in the case of setting the various kinds of items by using the document property screen, but also in the case of employing the graphical user interface in which various kinds of items are established by using an arbitral screen categorized by the tab, as well.

### SUMMARY OF THE INVENTION

To overcome the abovementioned drawbacks in conventional controlling apparatuses, it is one of objects of the present invention to provide a controlling apparatus, a controlling method and a computer readable recording medium storing a controlling program, which make it possible to improve the user's maneuverability at the time of setting operations to be conducted in the screen in which items, being different from each other corresponding to a selected tab, are indicated.

Accordingly, to overcome the cited shortcomings, at least one of the objects of the present invention can be attained by controlling apparatuses, described as follows.
(1) According to a controlling apparatus reflecting an aspect of the present invention, the controlling apparatus is provided with at least a setting control section that controls a display device to display a first screen, in which represented are a plurality of tabs and a plurality of items corresponding to a selected one of the tabs, wherein, when a given tab, which is not currently selected, is designated or pointed at, the setting control section controls the display device to display on or vicinity of a first screen a second screen, in which at least one of names of a plurality of items corresponding to the given tab is represented.
(2) According to another aspect of the present invention, in the controlling apparatus recited in item 1, setting information corresponding to the at least one of the names of the plurality of items that corresponds to the given tab are displayed on the second screen.
(3) According to still another aspect of the present invention, in the controlling apparatus recited in item 1, the setting control section arranges the names of the plurality of items on the second screen, according to an arranged order of them displayed on the first screen when the given tab is selected.
(4) According to yet another aspect of the present invention, in the controlling apparatus recited in item 1, among the plurality of items corresponding to the given tab, the setting control section disposes one of the items, of which a setting is changed from a default, at an upper portion in the second screen.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram of a configuration of a printing system embodied in the present invention;

FIG. 2 shows a block diagram indicating a configuration of a computer terminal device embodied in the present invention;

FIG. 3 shows a block diagram indicating functions to be conducted in a computer terminal device by a printer driver embodied in the present invention;

FIG. 4 shows a block diagram indicating a configuration of an image forming apparatus embodied in the present invention;

FIG. 5 shows a flowchart of controlling procedures to be employed in a computer terminal device embodied in the present invention;

FIG. 6 shows an exemplary configuration of a document property screen (when a fundamental setting tab is selected) to be displayed on a display section of a computer terminal device embodied in the present invention;

FIG. 7 shows an exemplary configuration of a document property screen (when a image quality tab is selected) to be displayed on a display section of a computer terminal device embodied in the present invention;

FIG. 8 shows an exemplary configuration of a document property screen (when a setting information notifying screen overlaps on a document property screen) to be displayed on a display section of a computer terminal device embodied in the present invention;

FIG. 9 shows another configuration of a setting information notifying screen embodied in the present invention;

FIG. 10 shows still another configuration of a setting information notifying screen embodied in the present invention; and

FIG. 11(a) and FIG. 11(b) show yet other configurations of a setting information notifying screen embodied in the present invention.

### DETAILED DESCRIPTION OF THE PREFERRED EMBODIMENT

In a preferred and exemplified embodiment of the present invention, in which a setting control section, configured as either hardware or software (printer driver), is installed in a controlling apparatus for controlling an image forming apparatus concerned. When the setting control section displays a screen (for instance, a document property screen) on which various items, such as a paper sheet, a layout, a finishing, a cover sheet/insertion paper sheet, a stamp/page printing, an image quality, etc., corresponding to the selected tab, if a predetermined tab, which is not currently selected, is pointed at by a pointer, a cursor, or other icons, the setting control section conducts a controlling operation for displaying the setting information notifying screen in which names of a single or a plurality of items and the setting information in regard to the concerned item, corresponding to the tab pointed at, are indicated. According to the above, the user can easily confirm the items corresponding to each of the tabs without frequently changing the various screens, resulting in an improvement of user's maneuverability.

### Embodiment

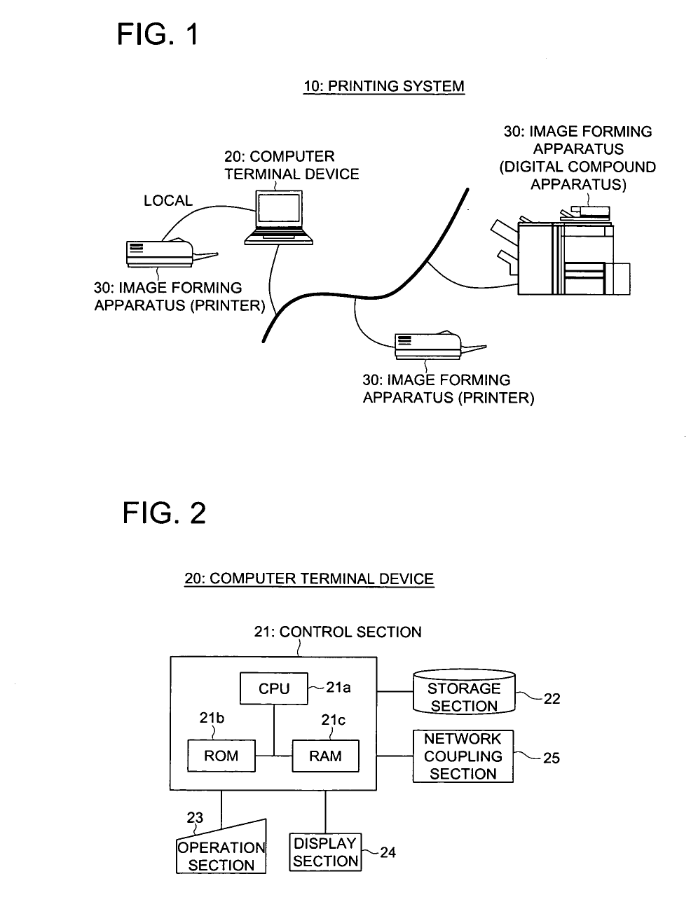

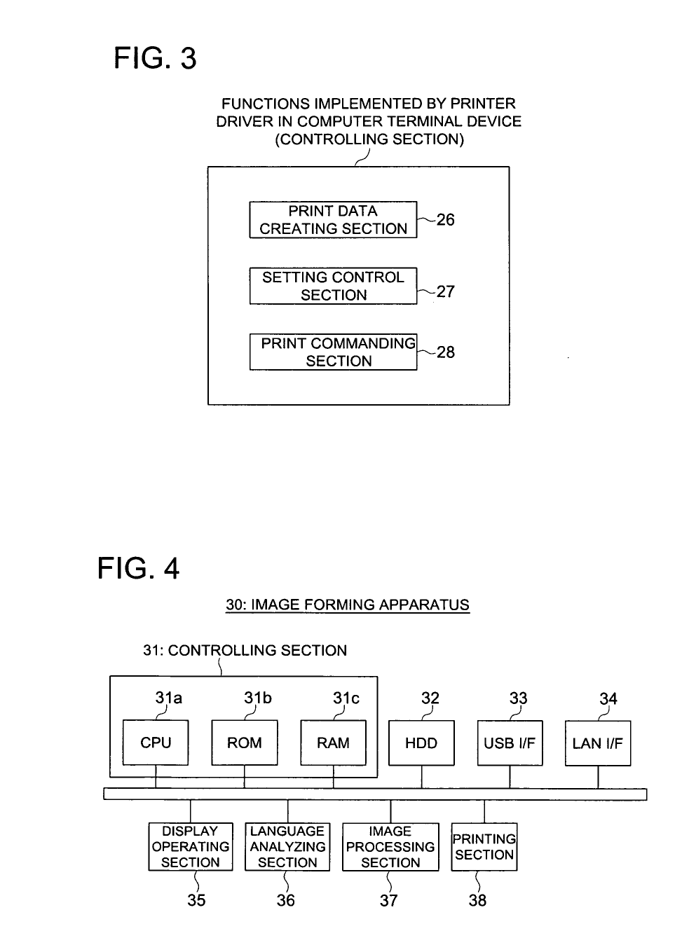

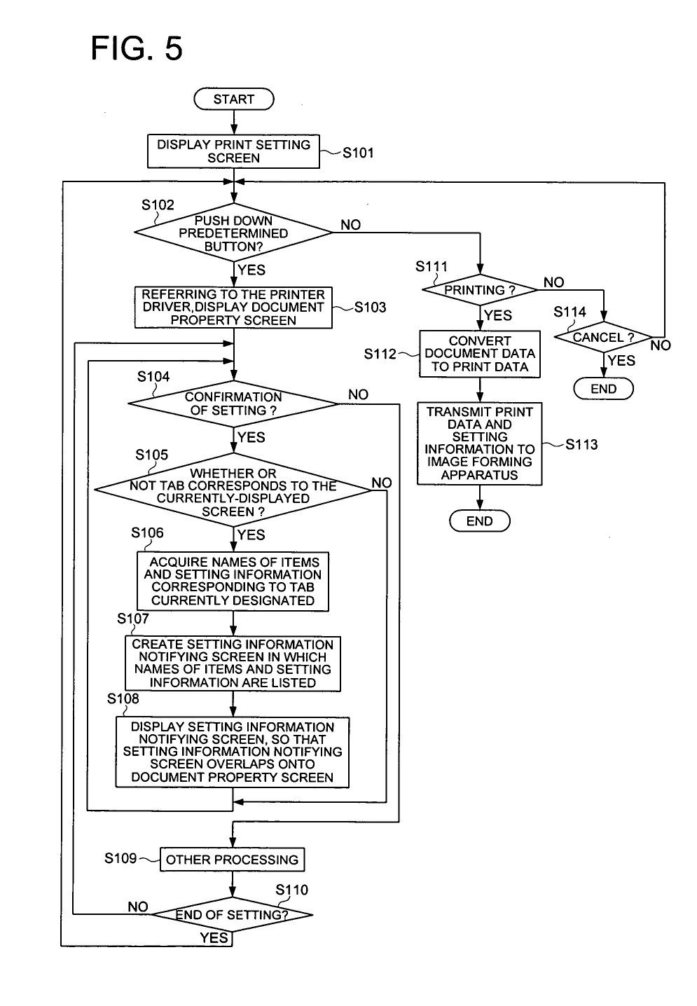

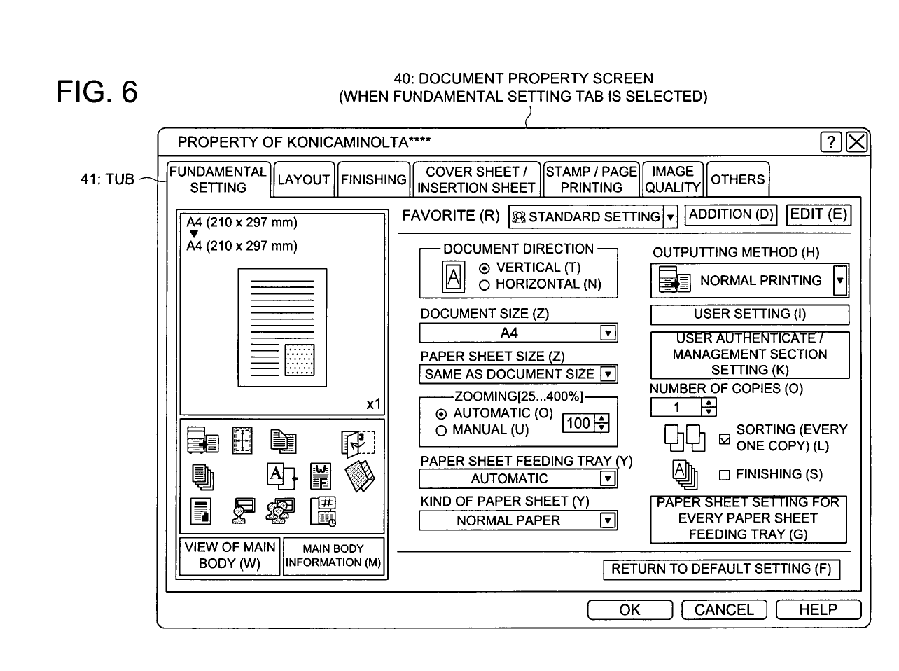

In order to describe the preferred and exemplified embodiment of the present invention in detail, referring to FIG. 1 through FIG. 11, a controlling apparatus, a controlling method and a controlling program, embodied in the present invention, will be detailed in the following. FIG. 1 shows a schematic diagram of a configuration of the printing system embodied in the present invention, FIG. 2 shows a block diagram indicating a configuration of a computer terminal device, FIG. 3 shows a block diagram indicating functions of the printer driver, and FIG. 4 shows a block diagram indicating a configuration of the image forming apparatus. Further, FIG. 5 shows a flowchart of the controlling procedures to be employed in the computer terminal device embodied in the present invention. Still further, FIGS. 6-11 show exemplary configurations of screens to be displayed on a display section of the computer terminal device.

As shown in FIG. 1, a printing system 10, embodied in the present invention, is constituted by: a single or a plurality of controlling apparatuses (hereinafter, referred to as computer terminal device(s) 20), each of which instructs the printing operation based on data (hereinafter, referred to as document data) created by an application program for creating the document (hereinafter, referred to as a document application program) or other data described in the Page Description Language converted from the document data (hereinafter, referred to as a print data); and a single or a plurality of image forming apparatuses 30, such as a printer, a digital multi-function peripheral, etc., which prints the document based on the print data acquired. The single or the plurality of computer terminal devices 20 and the single or the plurality of image forming apparatuses 30 are coupled to each other through a communication network, such as a LAN (Local Area Network), a WAN (Wide Area Network), etc.

Further, as shown in FIG. 2, the computer terminal device 20 is provided with a control section 21 including a CPU (Central Processing Unit) 21a, a ROM (Read Only Memory) 21b, a RAM (Random Access Memory) 21c, etc.; a storage section 22, such as a Hard Disc Drive, etc., to store various kinds of programs and data; an operation section 23, such as a keyboard, etc., to conduct various kinds of operations; a display section 24, such as an LCD (Liquid Crystal Display), etc., to display various kinds of screens detailed later; and a network coupling section 25, such as a NIC (Network Interface Card), a modem, etc., to couple the computer terminal device 20 to the communication network. In the normal operation, the OS (Operating System), the document application program and the device driver (hereinafter, referred to as the printer driver) are read form the ROM 21b or the storage section 22 into the RAM 21c, and are executed on the CPU 21a.

Further, by executing the print driver mentioned in the above, the control section 21 of the computer terminal device 20 serves as a print data creating section 26, a setting control section 27, a print commanding section 28, etc., as indicated in FIG. 3. Concretely speaking, the print data creating section 26 converts the document data to print data described in the Page Description Language so as to create the print data. Further, the setting control section 27 controls the display section 24 to display a screen in which various kinds of items for establishing the conditions for making the image forming apparatus 30 implement the printing operation are categorized into plural groups by corresponding tabs (hereinafter, referred to as a document property screen), so that the user can set the various kinds of items from the document property screen. Still further, the print commanding section 28 instructs the image forming apparatus 30 to implement the printing operation while transmitting the print data, etc. to the image forming apparatus 30.

In this connection, although a personal computer is indicated as the computer terminal device 20 in FIG. 1, any other device, such as, for instance, a PDA (Personal Digital Assistants) device, a Cellular Phone, etc., can be employed as the computer terminal device 20, as far as the concerned device is capable of instructing the printing operation based on the document data. Further, although the document application program and the printer driver are stored in the storage section 22 in the configuration shown in FIG. 1, it is also applicable that those programs are stored in another computer terminal device or a server coupled to the computer terminal device 20 through the communication network, so that the computer terminal device 20 can read out each of them from the other computer terminal device or the server when executing the program concerned, or the other computer terminal device or the server executes the program concerned.

Further, in the configuration shown in FIG. 3, the control section 21 of the computer terminal device 20 serves as the print data creating section 26, the setting control section 27 and the print commanding section 28, by executing the printer driver. However, since the document data can be processed in the image forming apparatus 30 when the document data is any one of data created complying with the XPS (XML Paper Specification), PDF (Portable Document Format) data, data described by the PS (Post Script), the PCL (Printer Control Language), etc., it is possible to omit the print data creating section 26 in any one of the abovementioned cases, or it is also possible to omit the print commanding section 28, if the document application program and/or the OS has a function as the print commanding section 28.

Still further, as shown in FIG. 4, the image forming apparatus 30 is constituted by a CPU 31a, a ROM 31b, a RAM 31c, an HDD (Hard Disc Drive) 32, a USB (Universal Serial Bus) interface 33, a LAN interface 34, a display operating section 35, a language analyzing section 36, an image processing section 37, a printing section 38, etc., all of which are coupled to each other through a bus.

The ROM 31b stores various kinds of programs and data necessary for controlling the overall operations of the image forming apparatus 30 in it. The RAM 31c temporarily stores data to be employed for a controlling operation currently conducted by the CPU 31a and/or other data to be temporarily stored during the controlling operation in it. Accordingly, in conjunction with the ROM 31b and the RAM 31c, the CPU 31 a serves as a controlling section 31 to control the overall operations of the image forming apparatus 30.

The HDD 32 stores various kinds of the print data, etc., acquired from the computer terminal device 20 in it.

The LAN interface 34 serves as an interface for coupling the image forming apparatus 30 to the communication network, such as a NIC, a modem, etc., so as to receive the print data, etc., transmitted from the computer terminal device 20.

The USB interface 33 serves as another interface for coupling various kinds of USB (Universal Serial Bus) devices, such as a USB memory, etc., to the image forming apparatus 30.

The display operating section 35 is constituted by a displaying section, such as an LCD (Liquid Crystal Display), etc., and an operating section, such as a touch panel, etc., so as to display icons, key-buttons and various kinds of settings necessary for the printing operation on the LCD or the like, and to output operational signals inputted from the touch panel or the like.

The language analyzing section 36 parses the print data acquired from the computer terminal device 20 through the LAN interface 34, so as to create new data described in an intermediate format (hereinafter, referred to as intermediate data) to be developed into other data described in a bitmap format (hereinafter, referred to as bitmap data) from the acquired print data.

The image processing section 37 creates the bitmap data, serving as printable data, from the intermediate data created by the language analyzing section 36.

The printing section 38 prints an image based on the bitmap data created by the image processing section 37. Concretely speaking, in the printing section 38, an exposure section irradiates a light (for instance, a laser beam) modulated according to the bitmap data onto a photoreceptor drum uniformly charged with electrostatic charge by a charging device, so as to form a latent image on the photoreceptor drum. Successively, a developing device develops the latent image with toner, and the developed toner image is finally transferred onto a paper medium through a primary transfer roller and a secondary transfer belt. Then, a fixing device fixes the toner image onto the paper medium.

In this connection, it is applicable that each of the language analyzing section 36 and the image processing section 37 can be configured as either a hardware structure or a computer program to be executed on the control section 31 so as to makes the computer serve as the language analyzing section 36 or the image processing section 37. Further, since the configuration shown in FIG. 4 is merely one of examples of the image forming apparatus 30 embodied in the present invention, it is also applicable that the USB interface 33, etc. can be excluded from the configuration, and/or a finisher that conducts various kinds of post processing, such as a staple processing, a punch processing, etc., is added to the configuration.

In this connection, as mentioned in the foregoing, the items are categorized into the plural groups corresponding to the tabs displayed on the document property screen, and the setting operation of the concerned items are conducted by sequentially displaying the screens corresponding to the selected tabs one by one. Therefore, in order to confirm what kind of items are settable in screens corresponding to tabs other than the tab currently selected, and to confirm what kinds of settings were applied to the items concerned, it has been indispensable to actually display the screen corresponding to the predetermined tab concerned. Accordingly, since the switching (shifting) operations between various screens have been cumbersome for the user, it has been a problem that the user's maneuverability at the time of the setting operation is bad.

To overcome the abovementioned problems, when a screen (for instance, a document property screen), on which a plurality of tabs and a plurality of items corresponding to the selected one of the tab are represented, is displayed on the display section 24, in response to a user's designation or pointing of a given tab conducted by employing a pointer or a cursor, the setting control section 27 acquires information in regard to the items corresponding to the given tab, and controls the display section 24 to display a screen, on which a list of the acquired information is displayed, on the document property screen, so that the user can confirm the information in regard to the concerned items on the list indicated in the screen, without actually displaying the screen for setting the items corresponding to the tab pointed. In another embodiment, the screen of the list regarding acquired information may be displayed in vicinity of the document property screen.

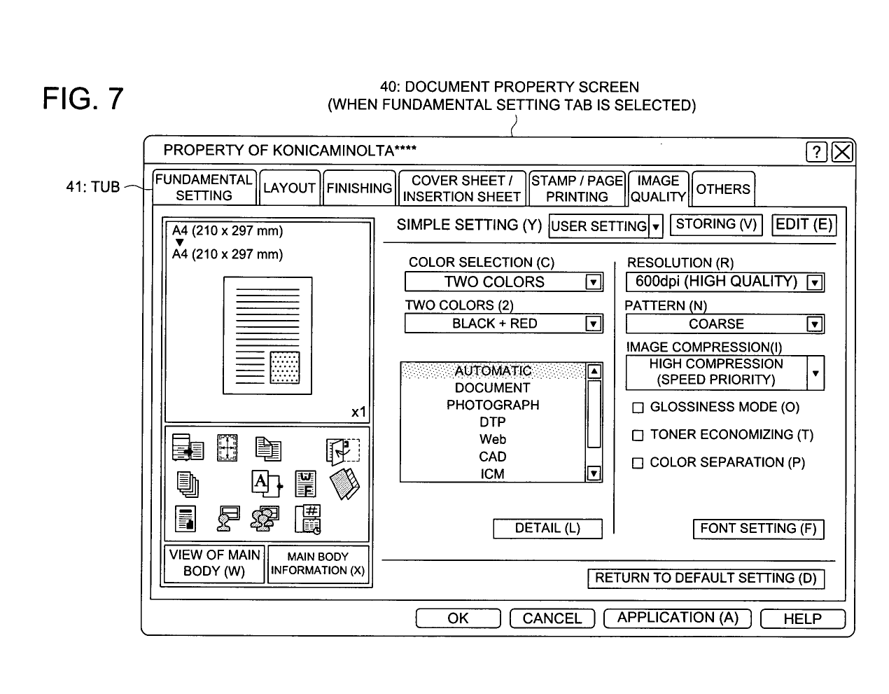

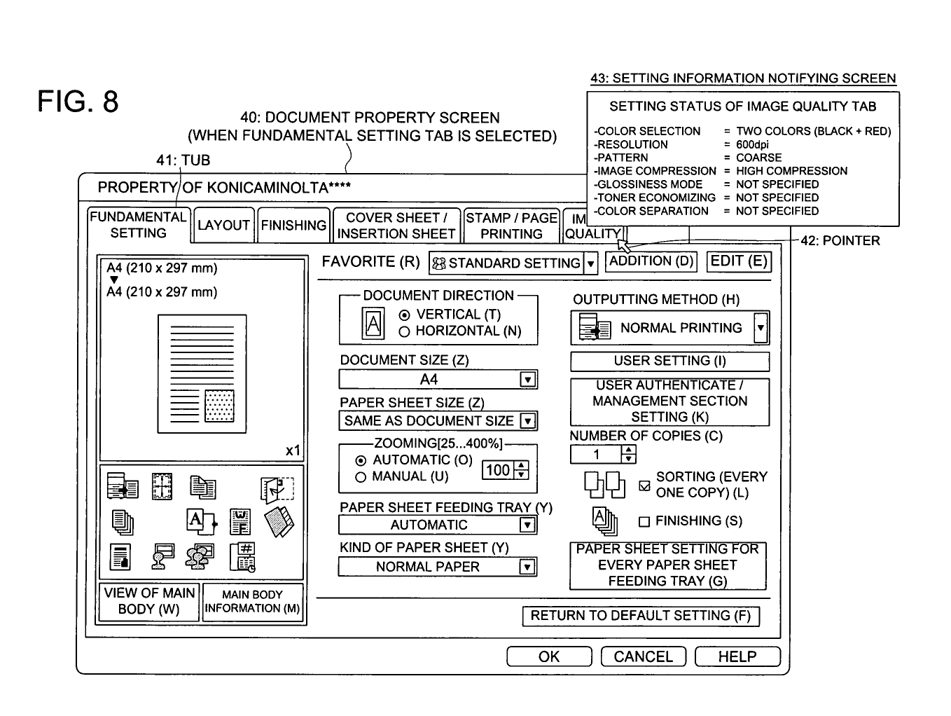

Concretely speaking, as shown in FIG. 6 and FIG. 7, a plurality of items are categorized into plural groups of items in the document property screen 40 by employing the tabs corresponding to the plural groups, wherein such the plural groups of items include: items in regard to the paper sheet, such as the document direction, the document size, the paper sheet feeding tray, etc.; items in regard to the layout, such as the page layout, the rotation, the kind of printing, the stapling direction, etc.; items in regard to the finishing operation, such as the stapling operation, a saddle stitching operation, the punching operation, the folding operation, the ejecting tray, etc.; items in regard to the cover sheet/insertion paper, such as the front cover, the rear cover, the OHP insertion paper, etc.; items in regard to the stamp/page printing, such as the watermark, the overlay, the copy protect, the page number, etc.; items in regard to the image quality, such as the selection of color, the resolution, the patterning, the image compression, etc.; etc. Further, during the time when a certain screen corresponding to one of predetermined tabs (for instance, the tab of “FUNDAMENTAL SETTING”) is currently displayed, when the user intends to confirm information in regard to another screen (for instance, “IMAGE QUALITY”) corresponding to another tab, the user designates or points at a tab 41 of “IMAGE QUALITY” by using a pointer 42, a cursor, etc., as shown in FIG. 8. Then, the setting control section 27 (or the printer driver) acquires the names of items included in the tab 41 of “IMAGE QUALITY” and the information indicating the setting status of the items (hereinafter, referred to as the setting information), and displays a setting information notifying screen 43, in which the names of items and the setting information of them, including: the color selection, such as the color or two-color, the gradation, the monochrome, etc.; the resolution setting, such as 600 dpi, 400 dpi, etc.; the setting of pattern density; the gloss mode or the toner economizing; the selection of color separation; etc., are displayed as the list, in such a manner that the setting information notifying screen 43 overlaps onto the document property screen 40 currently displaying the items in regard to the “FUNDAMENTAL SETTING”.

In this connection, although it is preferable that the listed information that is to be displayed on the screen corresponding to the tab 41 coincides with that displayed on the setting information notifying screen 43, it is not necessary that the display contents of both of them completely coincide with each other, as far as the corresponding relationship between them are clarified. For instance, it is applicable that both of them are different from each other in the dimension, the font, the color, etc. of letters, and/or, in the setting information notifying screen 43, an abbreviated designation for each item is displayed, a mark for clarifying each item is displayed, and/or, an added item relating to each item (such as added explanation, etc.) is also displayed.

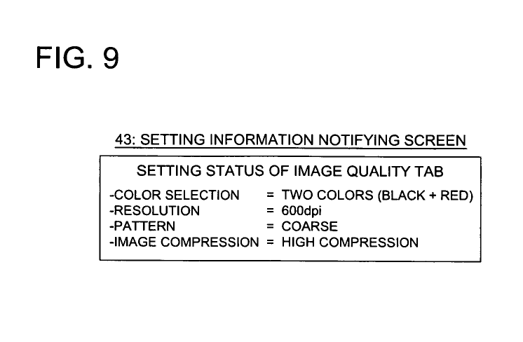

Further, although all of the items included in the tab of “IMAGE QUALITY”, shown in FIG. 7, are displayed on the setting information notifying screen 43 shown in FIG. 8, it is not necessary to display all of the items on the setting information notifying screen 43. For instance, it is also applicable that only the names of major items and the setting information of them are displayed as shown in FIG. 9, or when an item, which is restricted in advance to display on the screen, is exist, only the names of the items excluding the display-restricted item and the setting information of them are displayed. Still further, although the names of the items and the setting information of them are displayed on the setting information notifying screen 43 shown in FIG. 8 and FIG. 9, it is applicable that only the information, in regard to the screen corresponding to the tab 41 designated by the user, is displayed on the setting information notifying screen 43. For instance, as shown in FIG. 10, it is applicable that only the names of the items are displayed as the list.

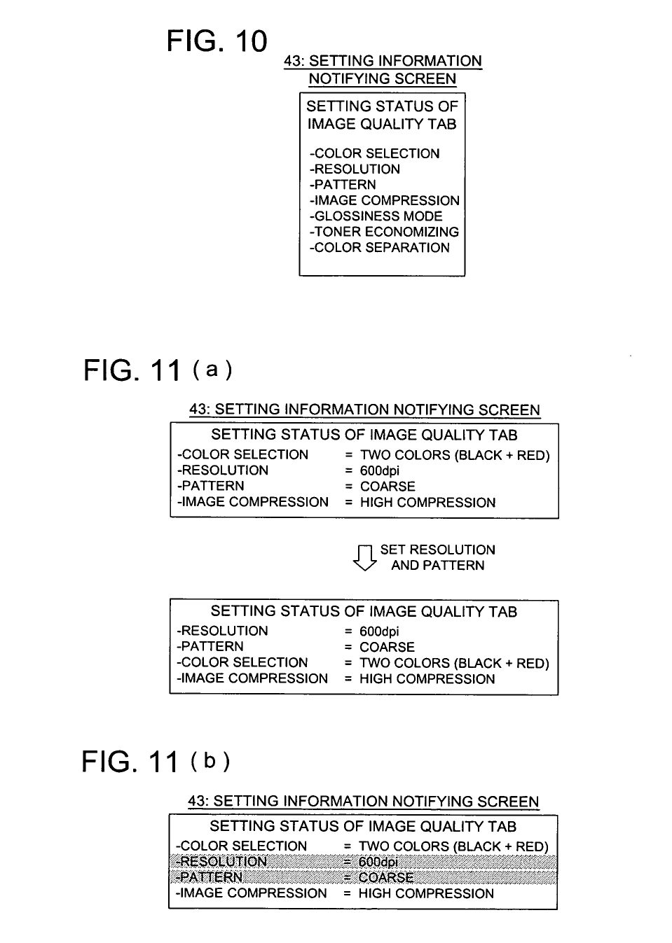

Still further, it is also applicable that the order of the items to be displayed as the list on the setting information notifying screen 43 is set at a predetermined order (for instance, an order of actually displaying them on the screen corresponding to the tab 41 designated by the user), or, when the setting operations in regard to only a part of items (for instance, the items of the “RESOLUTION”, and the “PATTERN” in the screen shown in FIG. 7) are completed, in order to make the confirmation of the currently-set item easy, the currently-set item is positioned at the first order line (herein, the item of the “COLOR SELECTION” is stepped down, while the items of the “RESOLUTION” and the “PATTERN” are stepped up) as shown in FIG. 11(a), or, as shown in FIG. 11(b), the color, the font, the dimension, etc. of the letters are changed, so as to make it easy to discriminate the currently-set items.

Still further, although the setting information notifying screen 43 can be displayed only by moving the pointer 42 or the cursor, etc. onto the given tab 41 in the abovementioned embodiment, it is also applicable that the setting information notifying screen 43 can be displayed by conducting a predetermined operation (for instance, a right clicking operation of the mouse) after moving the pointer 42 or the cursor, etc. onto the given tab 41. Alternatively, it is also applicable that the setting information notifying screen 43 can be displayed by depressing a button (for instance, one of function keys) corresponding to the given tab 41, instead of moving the pointer 42 or the cursor, etc. onto the given tab 41, or, when a touch panel, serving as both the display section 24 and the operation section 23, is employed, the setting information notifying screen 43 can be displayed by touching the given tab 41 once, while the screen corresponding to the concerned tab 41 can be displayed by touching the given tab 41 twice.

Still further, although the setting information notifying screen 43 is displayed within an area surrounded by the rectangular shaped frame in the configurations shown in FIG. 8 through FIG. 11, the dimensions and the shape of the frame can be arbitrarily designed. In addition, although the setting information notifying screen 43 is displayed at the position in the vicinity of the pointer 42 in the configurations shown in FIG. 8, its display position is also arbitrarily settable, as far as the corresponding relationship between the designated tab 41 and the setting information notifying screen 43 is clarified.

Next, referring to the flowchart shown in FIG. 5, the controlling operations to be conducted by the computer terminal device 20 of the present embodiment will be detailed in the following.

At first, in accordance with a predetermined operations by the user, the control section 21 reads out the document application program from the ROM 21b, the storage section 22, or the other computer terminal device or the server coupled through the communication network, etc., in order to activate the document application program on the own computer terminal device, or to activate it on the other computer terminal device or the server. Then, the user creates the document data, serving as an object to be printed, by using the document application program concerned. In this connection, the scope of the document data is not limited to one created in this step, but it is also applicable that the document data created in advance are acquired from the ROM 21b, the storage section 22, or the other computer terminal device or the server.

Successively, when the user conducts predetermined operations on the screen of the application program, the control section 21 controls the display section 24 to display the print setting screen for conducting operations for selecting the image forming apparatus 30, which implements the printing operation, and for setting pages to be printed, a number of copies, etc. (Step Still successively, the control section 21 determines whether or not the user depresses a predetermined button (in a typical case, the property button) provided in the print setting screen (Step S102). When determining that the user depresses the predetermined button (Step S102; Yes), the control section 21 proceeds to Step S103. In Step S103, the control section 21 serves as the setting control section 27 while referring to the printer driver by the printing function of the OS. Then, the setting control section 27 of the control section 21 (or the printer driver) controls the display section 24 so as to display the document property screen 40 shown in FIG. 6 and FIG. 7. In this connection, although the printer driver is executed on the computer terminal device 20 in the present embodiment, when the printer driver installed in the other computer terminal device or the server coupled to the computer terminal device 20 through the communication network can be commonly owned by the computer terminal device 20, it is also applicable that the printer driver is executed on the other computer terminal device or the server.

Still successively, by judging a current position of the pointer and presence or absence of an operation of clicking the mouse button, the control section 21 determines whether or not the user designates any one of the tabs indicated on the document property screen 40 (Step S104).

Then, when determining that the user designates or points at any one of the tabs (Step S104; Yes), the control section 21 controls the display section 24 to display the information in regard to the screen corresponding to the tab 41 currently designated by the pointer 42. On that occasion, if the user still designates the tab 41 corresponding to the currently-displayed screen, since the aforementioned effect cannot be achieved by merely displaying the information in regard to the currently-displayed screen, the setting control section 27 of the control section 21 (or the printer driver) determines whether or not the tab 41 currently designated by the pointer 42 corresponds to the currently-displayed screen (Step S105).

Successively, when determining that the tab 41 currently designated or pointed at by the pointer 42 does not correspond to the currently-displayed screen, the setting control section 27 of the control section 21 (or the printer driver) acquires the names of items settable in the screen corresponding to the tab 41 currently designated by the pointer 42 and the setting information of them from the storage section 22 and/or the RAM 21c (Step S106), and then, creates the setting information notifying screen 43 in which the names of items and the setting information are displayed as the list (Step S107), so as to display the setting information notifying screen 43 created in the above in such a manner that the setting information notifying screen 43 overlaps onto the document property screen 40 as shown in FIG. 8 (Step S108). Then, the control section 21 returns to the processing to be conducted in Step S104.

As mentioned in the foregoing, it is not necessary to display the names of all of the items and the setting information of them, which are settable on the screen corresponding to the tab 41 designated, but it is possible to appropriately establish the displaying mode, the displaying order, the displaying position, etc. of the setting information notifying screen 43 as needed, such as displaying only the names of the major items and setting information of them; omitting the names of items and setting information of them, which are banned to display, from the list to be actually displayed; displaying only the names of items concerned; giving a displaying priority to the item currently set by the user; etc. Further, it is also applicable that, even when the tab 41 currently designated by the user corresponds to the currently displayed screen, the setting information notifying screen 43 is displayed on the document property screen 40.

By viewing the setting information notifying screen 43, the user can confirm the name of each item or its setting status displayed on the screen corresponding to the tab 41 designated without switching the document property screen to the one corresponding to the tab 41 pointed at, as far as the user does not move the pointer from the tab 41. Further, since the control section 21 returns to the processing to be conducted in Step S104 after the processing in Step S108 is completed, when the user moves the pointer so as to designate the other tab 41, it is possible for the user to confirm the name of each item or its setting status displayed on the separate screen corresponding to the newly-designated tab 41.

On the other hand, when determining that the user does not designate any tab (Step S104; No), the control section 21 proceeds to Step S109 to conduct any one of other operations. The other operations include: a first operation to be conducted when the user clicks or selects any one of the tabs 41 to select the tab 41 concerned; a second operation to be conducted when the user conducts setting operations in regard to the various kinds of items currently displayed on the screen; a third operation to be conducted when the user clicks or selects any one of the OK button and the cancel button displayed on the document property screen; etc. In the case of the first operation, the setting control section 27 (or the printer driver) displays the screen including the displaying items categorized by the tab 41 selected by the user (Step S109). Further, in the case of the second operation, the setting control section 27 (or the printer driver) stores the names of the items and the setting information of them (in regard to the item, which is not set by the user, the default setting information) into the storage section 22, the RAM 21c, etc., while correlating them with each other (Step S109). Still further, in the case of the third operation, the setting control section 27 (or the printer driver) conducts such an operation that makes the document property screen enter into the non-display mode (Step S109).

Successively, the controlling process enters into Step S110 in which the control section 21 determines whether or not the setting operations to be conducted in the document property screen 40 are completed. When determining that the setting operations are completed (Step S110; Yes), the control section 21 returns to the print setting screen in Step S102. On the other hand, when determining that the setting operations are not completed (Step S110; No), the control section 21 returns to the processing to be conducted in Step S104.

Again, with respect to Step S102, when determining that the user does not depress the predetermined button (in the typical case, the property button) (Step S102; No), the control section 21 further determines whether or not the user depressed the other predetermined button (in a typical case, the printing button) provided in the print setting screen (Step S111). When determining that the user depresses the predetermined button (Step S111; Yes), the print data creating section 26 of the control section 21 (or the printer driver) creates the print data by converting the document data to the data described in the Page Description Language (Step S112). Successively, the print commanding section 28 of the control section 21 (or the printer driver) transmits the print data and the setting information of the document property screen 40 to the image forming apparatus 30, so as to make the image forming apparatus 30 implement the printing operation based on the document data concerned (Step S113).

On the other hand, when determining that the user does not depress the predetermined button (Step S111; No), the control section 21 further determines whether or not the user depresses the cancel button provided in the print setting screen (Step S114). When determining that the user depresses the cancel button (Step S114; Yes), the control section 21 conducts such an operation that makes the print setting screen enter into the non-display mode, without conducting the printing operation, while, when determining that the user does not depress the cancel button (Step S114; No), the print commanding section 28 of the control section 21 returns to Step S102, in order to repeat the abovementioned processing.

As described in the foregoing, according to the present embodiment, when making the display section 24 display the screen in which the setting items are categorized into groups corresponding to the tabs 41 such as the document property screen 40, the setting control section 27 of the control section 21 (or the printer driver) acquires the names of the items and the setting information of them to be displayed on the screen corresponding to the given tab 41 designated with the pointer 42 by the user, and then, controls the display section 24 to display the setting information notifying screen 43 in which the acquired names of the items and the setting information of them are indicated as the list in such a manner that the setting information notifying screen 43 overlaps onto the document property screen 40. Accordingly, it becomes possible for the user to confirm the names of the items and the setting information of them by viewing the setting information notifying screen 43 without actually displaying the screen corresponding to the tab 41 concerned, and therefore, it is not necessary for the user to change the screens many times, resulting in improvement of the maneuverability at the time of the setting operation.

In this connection, although the document property screen displayed by executing the printer driver is exemplified in the preferred embodiment described in the foregoing, the scope of the present invention is not limited to the aforementioned embodiment. For instance, the present invention can be also applied to such a case that arbitral items are set by employing an arbitral screen categorized by a plurality of tabs, as well, such as a case in which various kinds of setting operations are conducted by employing a screen displayed by executing a document application program, etc.

The present invention is applicable not only for a controlling apparatus to control an image forming apparatus, a controlling method to be employed in the controlling apparatus concerned and a printer driver for controlling the image forming apparatus operated by the controlling apparatus concerned, but also for an apparatus to conduct setting operations of various kinds of items, a controlling method to be employed in the apparatus concerned and a program to control settings.

According to the controlling apparatus, the controlling method and the controlling program, each embodied in the present invention, it becomes possible to improve the user's maneuverability at the time of setting operations to be conducted in the screen in which items, being different from each other corresponding to a selected tab, are indicated.

This is because, in the case that the setting control section of the controlling apparatus (or the controlling program) makes the display section display the main screen in which items, being different from each other corresponding to the selected tab, are indicated, when the user designates a predetermined tab, which is not currently selected, with a cursor or a pointer, the setting control section controls the display section to display the setting information notifying screen in which a name of a single one of items or names of a plurality of items, or the name of the single one of items or the names of the plurality of items and setting information of items corresponding to the predetermined tab, is/are indicated as the list. Accordingly, it becomes possible for the user to easily confirm the items corresponding to each of the tabs without changing the screens many times.

While the preferred embodiments of the present invention have been described using specific term, such description is for illustrative purpose only, and it is to be understood that changes and variations may be made without departing from the spirit and scope of the appended claims.

What is claimed is:

1. A controlling apparatus provided with at least a setting control section that controls a display device to display a first screen, in which represented are a plurality of tabs and a plurality of items corresponding to a selected one of the tabs,
wherein, when a given tab, which is not currently selected, is designated, the setting control section controls the display device to display on or vicinity of the first screen a second screen, in which at least one of names of a plurality of items corresponding to the given tab is represented.

2. The controlling apparatus of claim 1,
wherein setting information corresponding to the at least one of the names of the plurality of items that corresponds to the given tab is displayed on the second screen.

3. The controlling apparatus of claim 1,
wherein the setting control section arranges the names of the plurality of items on the second screen, according to an arranged order of them on the first screen when the given tab is selected.

4. The controlling apparatus of claim 1,
wherein, among the plurality of items corresponding to the given tab, the setting control section disposes one of the items, of which a setting is changed from a default, at an upper portion in the second screen.

5. A controlling method, comprising:
displaying a first screen, in which represented are a plurality of tabs and items corresponding to a selected one of the tabs; and
displaying a second screen on or vicinity of the first screen, when a given tab, which is not currently selected, is designated;
wherein at least one of names of a plurality of items corresponding to the given tab is represented on the second screen.

6. The controlling method of claim 5,
wherein setting information corresponding to the at least one of the names of the plurality of items that corresponds to the given tab is displayed on the second screen.

7. The controlling method of claim 5,
wherein, in the step of displaying the second screen, the names of the plurality of items are arranged on the second screen, according to an arranged order of them on the first screen when the given tab is selected.

8. The controlling method of claim 5,
wherein, in the step of displaying the second screen, among the plurality of items corresponding to the given tab, one of the items, of which a setting is changed from a default, is disposed at an upper portion in the second screen.

9. A computer readable medium storing a computer executable program for controlling a display device, the program comprising program code for causing a computer to perform the steps of:
displaying a first screen, in which represented are a plurality of tabs and a plurality of items corresponding to a selected one of the tabs; and
displaying a second screen on or vicinity of the first screen, when a given tab, which is not currently selected, is designated;
wherein at least one of names of a plurality of items corresponding to the given tab is represented on the second screen.

10. The computer readable medium of claim 9,
wherein setting information corresponding to the at least one of the the names of the plurality of items that corresponds to the given tab is displayed on the second screen.

11. The computer readable medium of claim 9,
wherein, in the step of displaying the second screen, the names of the plurality of items are arranged on the second screen, according to an arranged order of them on the first screen when the given tab is selected.

12. The computer readable medium of claim 9,
wherein, in the step of displaying the second screen, among the plurality of items corresponding to the given tab, one of the items, of which a setting is changed from a default, is disposed at an upper part in the second screen.
